(19) United States
(12) Patent Application Publication
(10) Pub. No.: US 2026/0255204 A1
(43) Pub. Date: Aug. 27, 2026

(54) IDENTIFICATION OF QUANTITY OF CHANNEL STATE INFORMATION PROCESSING UNITS

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/163,713

(22) PCT Filed: May 4, 2023
(86) PCT No.: PCT/CN2023/091985

§ 371 Date: Sep. 9, 2025

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may transmit capability information indicating a capability associated with one or more channel state information (CSI) processing units (CPUs). The UE may receive a message activating a CSI report. The UE may identify a quantity of the one or more CPUs that are associated with the CSI report, wherein the CSI report includes at least one predicted channel characteristic. Numerous other aspects are described.

### FIELD OF THE DISCLOSURE

Aspects of the present disclosure generally relate to wireless communication and to techniques and apparatuses for identifying a quantity of channel state information (CSI) processing units (CPUs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information (CSI) reference signal beam management procedures, in accordance with the present disclosure.

FIG. 5 is a diagram illustrating an example of beam management, in accordance with the present disclosure.

FIG. 6 is a diagram illustrating an example of an artificial intelligence and/or machine learning based beam management, in accordance with the present disclosure.

FIG. 7 is a diagram illustrating an example associated with identifying a quantity of CSI processing units (CPUs), in accordance with the present disclosure.

FIG. 8 is a diagram illustrating an example associated with reducing a quantity of occupied CPUs, in accordance with the present disclosure.

FIG. 9 is a diagram illustrating aspects associated with identifying one or more durations of CPUs associated with the CSI report, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### SUMMARY

Some aspects described herein relate to a user equipment (UE) for wireless communication. The UE may include one or more memories and one or more processors coupled to the one or more memories. The one or more processors may be configured to transmit capability information indicating a capability associated with one or more channel state information (CSI) processing units (CPUs). The one or more processors may be configured to receive a message activating a CSI report. The one or more processors may be configured to identify a quantity of the one or more CPUs that are associated with the CSI report, wherein the CSI report includes at least one predicted channel characteristic.

Some aspects described herein relate to a network node for wireless communication. The network node may include one or more memories and one or more processors coupled to the one or more memories. The one or more processors may be configured to obtain capability information indicating a capability associated with one or more CPUs. The one or more processors may be configured to output a message activating a CSI report, wherein the message prompts a UE to identify a quantity of the one or more CPUs that are associated with the CSI report, and wherein the CSI report includes at least one predicted channel characteristic.

Some aspects described herein relate to a method of wireless communication performed by a UE. The method may include transmitting capability information indicating a capability associated with one or more CPUs. The method may include receiving a message activating a CSI report. The method may include identifying a quantity of the one or more CPUs that are associated with the CSI report, wherein the CSI report includes at least one predicted channel characteristic.

Some aspects described herein relate to a method of wireless communication performed by a network node. The method may include obtaining capability information indicating a capability associated with one or more CPUs. The method may include outputting a message activating a CSI report, wherein the message prompts a UE to identify a quantity of the one or more CPUs that are associated with the CSI report, and wherein the CSI report includes at least one predicted channel characteristic.

Some aspects described herein relate to a non-transitory computer-readable medium that stores a set of instructions for wireless communication by a UE. The set of instructions, when executed by one or more processors of the UE, may cause the UE to transmit capability information indicating a capability associated with one or more CPUs. The set of instructions, when executed by one or more processors of the UE, may cause the UE to receive a message activating a CSI report. The set of instructions, when executed by one or more processors of the UE, may cause the UE to identify a quantity of the one or more CPUs that are associated with the CSI report, wherein the CSI report includes at least one predicted channel characteristic.

Some aspects described herein relate to a non-transitory computer-readable medium that stores a set of instructions for wireless communication by a network node. The set of instructions, when executed by one or more processors of the network node, may cause the network node to obtain capability information indicating a capability associated with one or more CPUs. The set of instructions, when executed by one or more processors of the network node, may cause the network node to output a message activating a CSI report, wherein the message prompts a UE to identify a quantity of the one or more CPUs that are associated with the CSI report, and wherein the CSI report includes at least one predicted channel characteristic.

Some aspects described herein relate to an apparatus for wireless communication. The apparatus may include means for transmitting capability information indicating a capability associated with one or more CPUs. The apparatus may include means for receiving a message activating a CSI report. The apparatus may include means for identifying a quantity of the one or more CPUs that are associated with the CSI report, wherein the CSI report includes at least one predicted channel characteristic.

Some aspects described herein relate to an apparatus for wireless communication. The apparatus may include means for obtaining capability information indicating a capability associated with one or more CPUs. The apparatus may include means for outputting a message activating a CSI report, wherein the message prompts a UE to identify a quantity of the one or more CPUs that are associated with the CSI report, and wherein the CSI report includes at least one predicted channel characteristic.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

A user equipment (UE) may occupy one or more channel state information (CSI) processing units (CPUs) to generate a CSI report. However, in some cases, a CSI report may include predicted channel characteristics (e.g., predicted beam characteristics), and a quantity of CPUs to be occupied is not specifically defined for CSI reports that include predicted channel characteristics. Without a CPU quantity specific to predicted channel characteristics, the UE may dedicate extraneous CPUs for generating CSI reports that include predicted channel characteristics. These extraneous CPUs may occupy UE resources that could, if unoccupied, be used for other purposes by the UE.

Various aspects relate generally to wireless communication, and more specifically to CPUs. Some aspects more specifically relate to identifying a quantity of CPUs (e.g., CPUs occupied for a CSI report that includes predicted channel characteristics). In some examples, a UE may transmit capability information indicating a capability associated with one or more CPUs and may receive a message activating a CSI report. The UE may identify a quantity of the one or more CPUs that are associated with the CSI report. In some examples, the CSI report may include at least one predicted channel characteristic (e.g., beam prediction result).

In a further example, the UE may determine that the one or more CPUs associated with the CSI report are unoccupied and, based at least in part on the determination that the one or more CPUs associated with the CSI report are unoccupied, may transmit the CSI report. Transmitting the CSI report (e.g., which may include at least one predicted channel characteristic) may enable a network node to perform beam management.

In some aspects, the UE may identify one or more durations of the CPU(s) associated with the CSI report that includes at least one predicted channel characteristic. For example, identifying the duration(s) may include identifying a start time of CPU occupation, an end time of CPU occupation, a length of time of CPU occupation, or the like. Identifying the duration(s) may help to ensure that the CPUs are not occupied for extraneous time.

Particular aspects of the subject matter described in this disclosure can be implemented to realize one or more of the following potential advantages. In some examples, by identifying the quantity of the one or more CPUs that are associated with the CSI report, the described techniques may enable reduction in overall CPU occupation, thereby decreasing computational burden on the UE. For example, identifying the quantity of the one or more CPUs may enable the UE to generate and report predictions (e.g., predicted channel characteristics) using artificial intelligence (AI)/machine learning (ML) techniques, which may allow the UE to occupy fewer CPUs.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

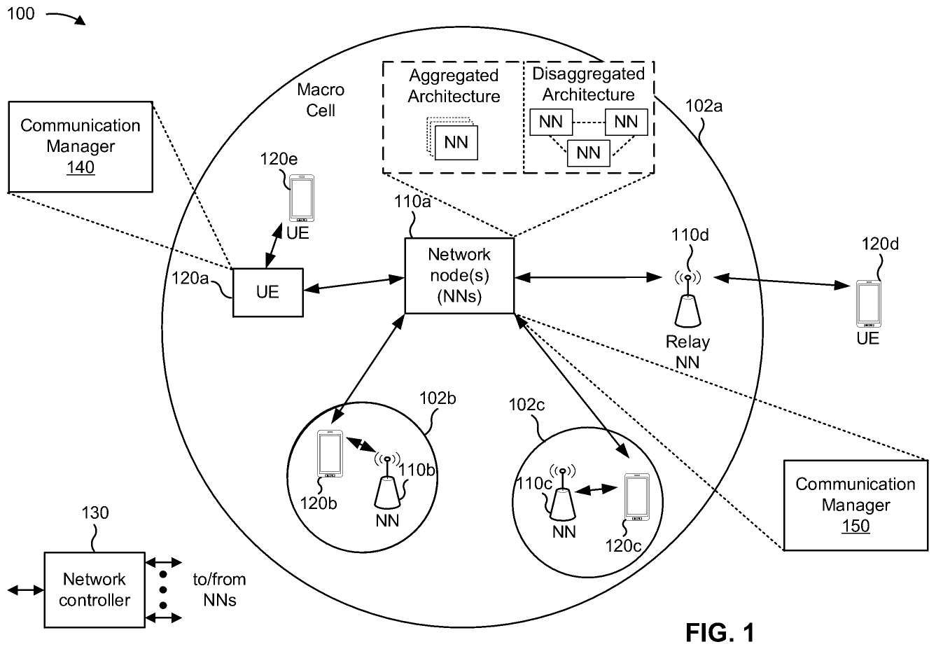

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit capability information indicating a capability associated with one or more CPUs, receive a message activating a CSI report, and identify a quantity of the one or more CPUs that are associated with the CSI report, wherein the CSI report includes at least one predicted channel characteristic. Additionally, or alternatively, the communication manager 140 may perform one or more other operations described herein.

In some aspects, the network node 110 may include a communication manager 150. As described in more detail elsewhere herein, the communication manager 150 may obtain capability information indicating a capability associated with one or more CPUs, and output a message activating a CSI report, wherein the message prompts the UE 120 to identify a quantity of the one or more CPUs that are associated with the CSI report, and wherein the CSI report includes at least one predicted channel characteristic. Additionally, or alternatively, the communication manager 150 may perform one or more other operations described herein.

As indicated above, FIG. 1 is provided as an example. Other examples may differ from what is described with regard to FIG. 1.

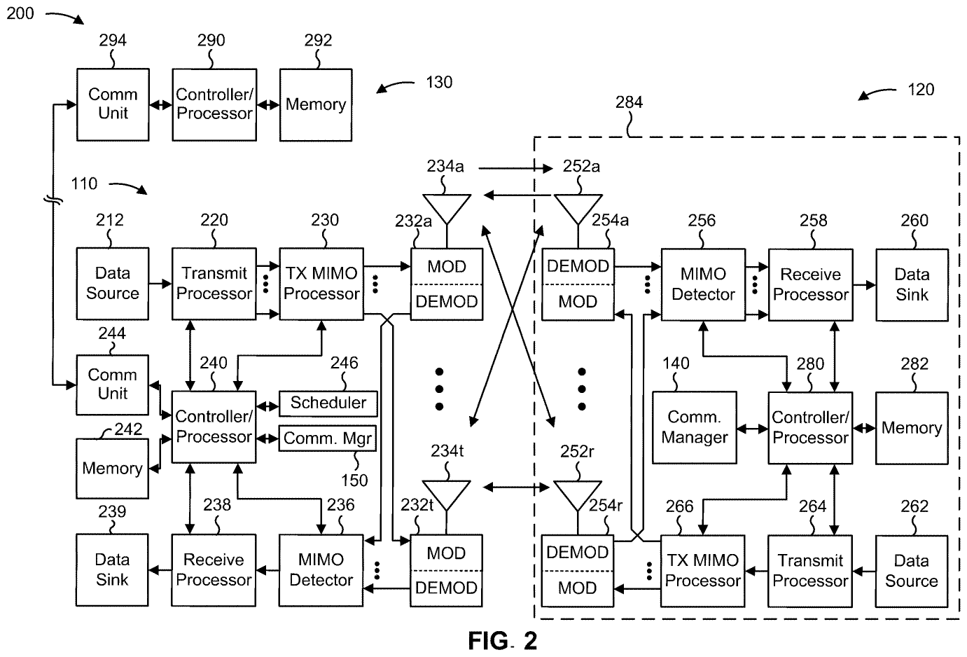

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

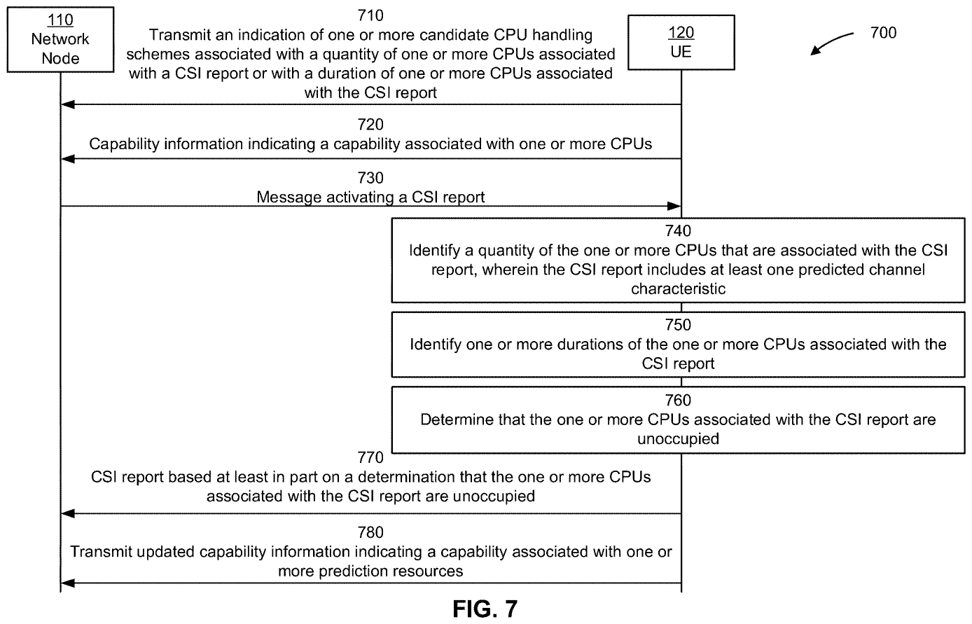

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-13).

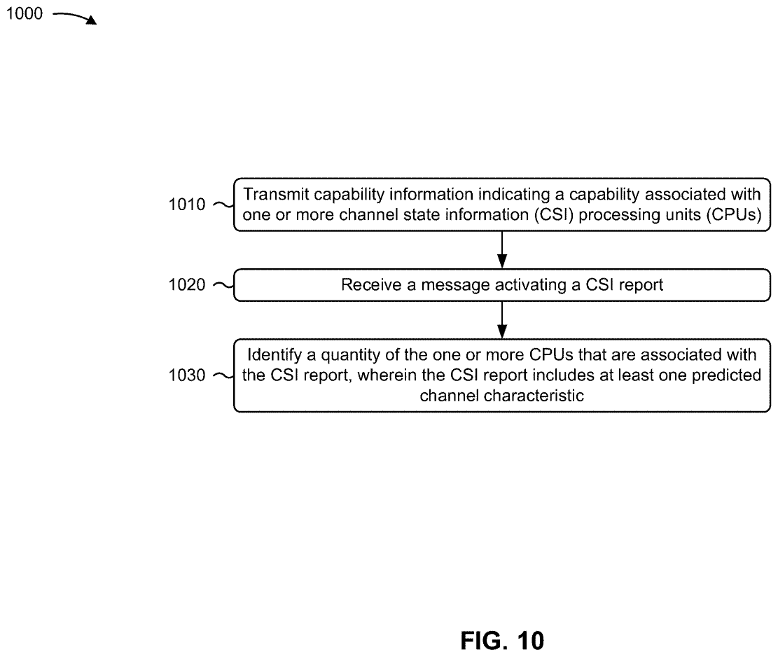

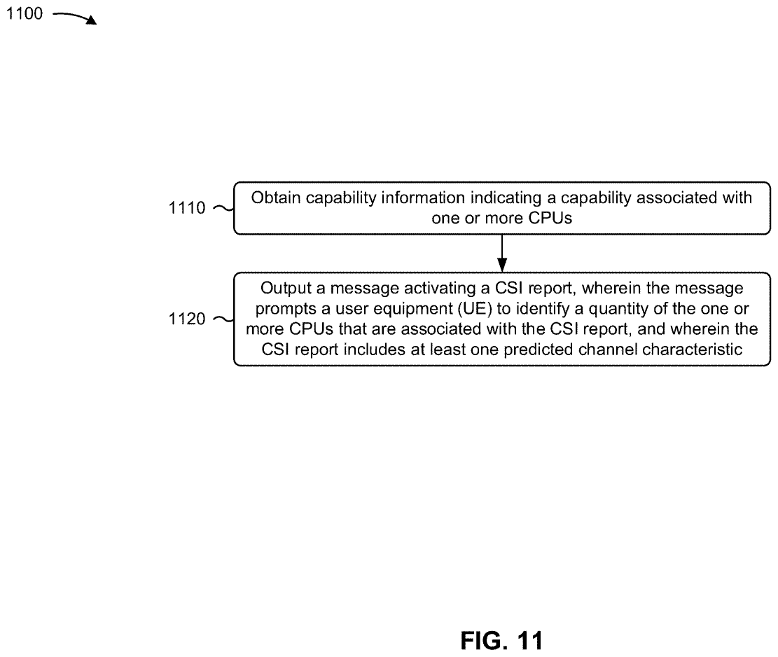

The controller/processor 240 of the network node 110, the controller/processor 280 of the UE 120, and/or any other component(s) of FIG. 2 may perform one or more techniques associated with identification of a quantity of CPUs, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for transmitting capability information indicating a capability associated with one or more CPUs; means for receiving a message activating a CSI report; and/or means for identifying a quantity of the one or more CPUs that are associated with the CSI report, wherein the CSI report includes at least one predicted channel characteristic. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for obtaining capability information indicating a capability associated with one or more CPUs; and/or means for outputting a message activating a CSI report, wherein the message prompts the UE 120 to identify a quantity of the one or more CPUs that are associated with the CSI report, and wherein the CSI report includes at least one predicted channel characteristic. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

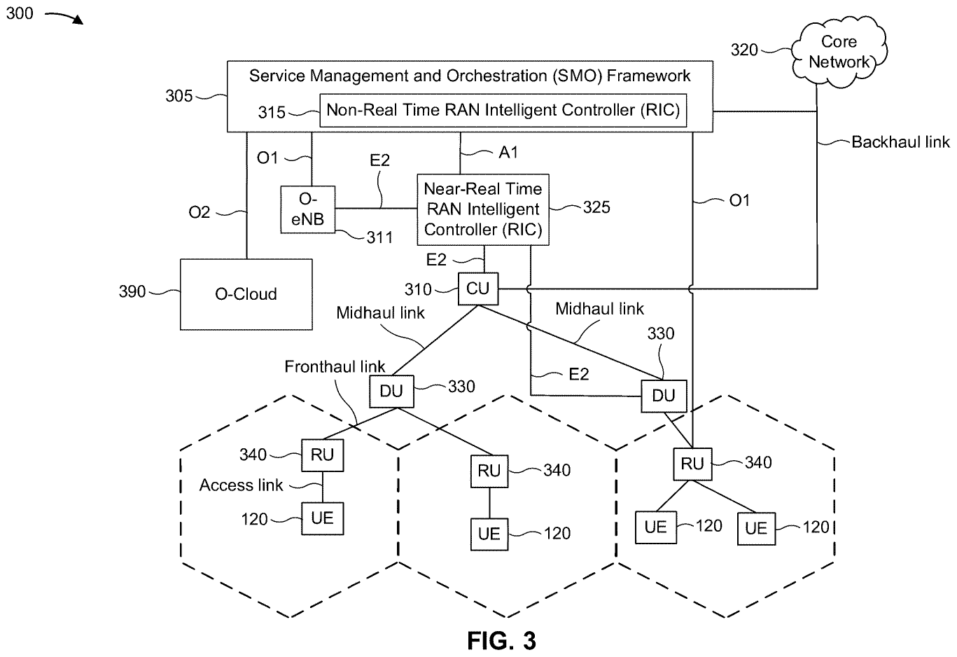

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, AI/ML workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

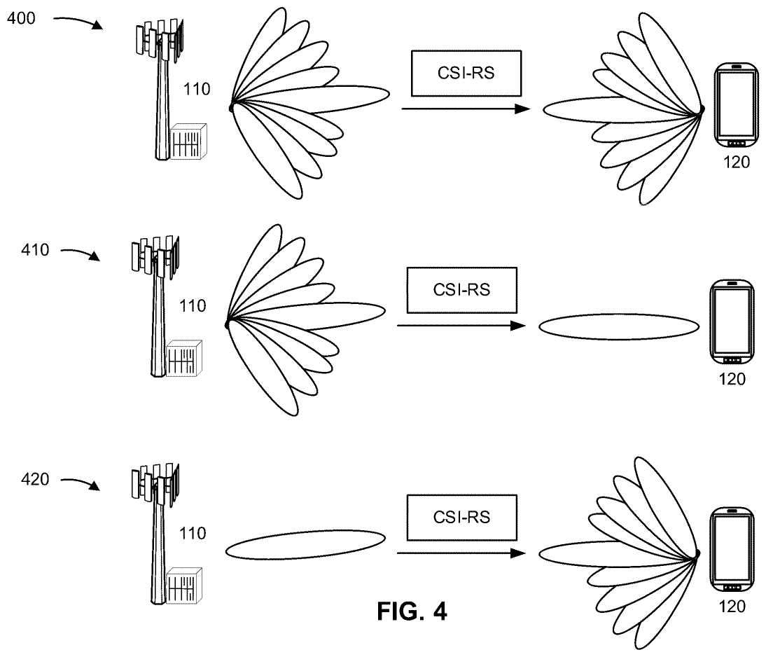

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

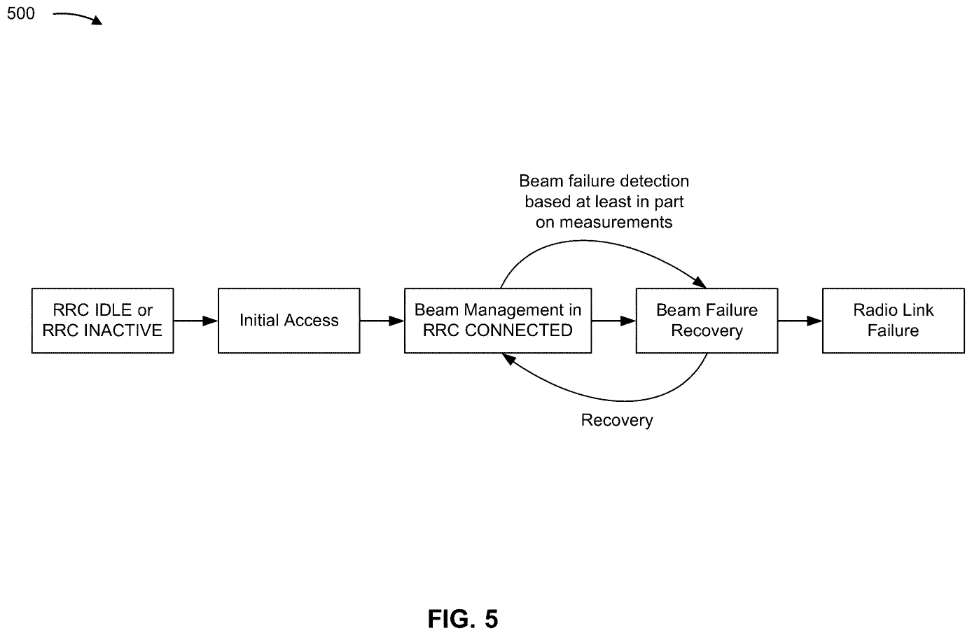

FIG. 5 is a diagram illustrating an example 500 of beam management, in accordance with the present disclosure. As shown, a UE may initially be in an RRC idle state or an RRC inactivate state. The UE may perform an initial access and may perform beam management after entering an RRC connected state as a result of the initial access. The UE may perform a beam failure detection (BFD), and the UE may perform a beam failure recovery (BFR) based at least in part on the BFD. When the BFR is not successful, the UE may declare a radio link failure (RLF).

In some examples, the initial access may involve SSB wide beam sweeping. In some examples, the initial access may involve contention-based random access (CBRA).

In some examples, the beam management may include P1, P2, and/or P3 beam management procedures, as described herein. In some examples, the beam management may include U1, U2 and/or U3 beam management procedures, which may be based on sounding reference signals (SRSs). The P1, P2, and/or P3 beam management procedures may be downlink beam management procedures, and the U1, U2 and/or U3 beam management procedures may be uplink beam management procedures. In some examples, the beam management may be based on Layer 1 reference signal received power (L1-RSRP) measurements. L1-RSRP measurements may be reported by the UE, or L1-RSRP measurements may be measured by the UE. The L1-RSRP measurements that are reported by the UE may be used to perform an inference at the network node. The L1-RSRP measurements that are measured by the UE may be used to perform an inference at the UE. In some examples, the beam management may be based on one or more transmission configuration indication (TCI) states of the beam(s).

In some examples, the beam management may involve one or more of Layer 1 (L1) signal-to-interference-plus-noise ratio (SINR) reporting, overhead and latency reduction (e.g., based on beam updates for a component carrier group (CC-group) and/or faster uplink), or the like. In some examples, the beam management may involve further latency and efficient enhancements (e.g., unified TCI states, L1/Layer 2 (L2)—centric mobility, dynamic TCI updates, uplink multi-panel selection, maximum permissible exposure (MPE) mitigation, further beam management latency reduction, or the like), high-speed train (HST)/single frequency network (SFN) scenarios, beam management for multiple transmission and reception point (mTRP), or the like.

The UE may perform BFD and BFR for primary cell (Pcell) and/or primary and secondary cell (PScell) BFR. For example, the UE may perform BFD via BFD reference signals (BFD-RSs) and physical downlink control channel (PDCCH) block error rate (BLER), BFR based on contention-free random access (CFRA), or the like. Additionally, or alternatively, the UE may perform BFD and BFR for secondary cell (Scell). For example, the UE may transmit a link recovery request via a scheduling request (SR) and/or may perform BFD for Scell based on MAC-CE messaging.

As indicated above, FIG. 5 is provided as an example. Other examples may differ from what is described with regard to FIG. 5.

One or more AI/ML models may be used for facilitating wireless communication tasks. Lifecycle management of an AI/ML model may involve model training, model deployment, model inference, model monitoring, and model updating. The model training may involve AI/ML model training (e.g., offline training), validation, and/or testing, among other examples. AI/ML model training may also involve data preparation (e.g., data pre-processing, data cleaning, data formatting, and/or transformation, among other examples) based on training data delivered by the data collection function. The model deployment may include deploying the AI/ML model (e.g., at a UE or a network node).

The model inference may involve providing inference data as input data to the AI/ML model and obtaining an AI/ML model inference output (e.g., predictions, classifications, estimations, and/or decisions, among other examples). In some cases, the model inference may involve providing model performance feedback to the model training function. The model inference may also involve performing data preparation (e.g., data pre-processing, data cleaning, data formatting, and/or transformation, among other examples) based on inference data.

The model monitoring may involve monitoring the AI/ML model for model performance (e.g., how often, and/or to what extent, predictions generated by the AI/ML model are correct). For example, poor performance by an AI/ML model (e.g., if the accuracies of the predictions of the AI/ML model fall below a threshold) may trigger a fallback to a non-AI/ML model. Model updating may involve retraining the AI/ML model or switching to a different AI/ML model. In some examples, model monitoring may trigger model updating.

AI/ML-based predictive beam management may involve beam management using AI/ML. One problem with traditional beam management procedures is that beam qualities/failures are identified via measurements, which may require power/overhead to achieve good performance. Further, beam accuracy may be limited due to restrictions on power/overhead, and latency/throughput may be impacted by beam resuming efforts. AI/ML-based predictive beam management may provide predictive beam management in a spatial domain (SD), time domain (TD), and/or frequency domain (FD), and may result in latency and overhead reduction and/or beam selection accuracy improvement.

For AI/ML-based beam management, a first case of beam management and a second case of beam management may be supported for characterization and baseline performance evaluations. In the first case, an SD downlink beam prediction for a Set A of beams may be based at least in part on measurement results of a Set B of beams. In the second case, a temporal downlink beam prediction for a Set A of beams may be based at least in part on historic measurement results of a Set B of beams. Thus, Set A may correspond to an output of the ML model, and Set B may correspond to an input of the model. Beams in Set A and beams in Set B may be in the same frequency range.

For the first case, a first alternative and a second alternative may be defined. In the first alternative, the beams in Set B may be a subset of the beams in Set A. A quantity of beams in Set A and a quantity of beams in Set B may be defined. The beams in Set B may be determined from the beams in Set A based at least in part on a fixed pattern or a random pattern. In the second alternative, the beams in Set A may be different than the beams in Set B (e.g., the beams in set B may not be a subset of the beams in Set A). For example, the beams in Set A may be associated with narrow beams, and the beams in Set B may be associated with wide beams. A quantity of beams in Set A and a quantity of beams in Set B may be defined. A quasi-co-location (QCL) relation may be defined between beams in Set A and beams in Set B. With respect to the first alternative and the second alternative, Set A may be associated with a downlink beam prediction and Set B may be associated with a downlink beam measurement. A codebook construction for Set A and a codebook construction for Set B may be defined.

For a UE-side AI/ML model (e.g., an AI/ML model deployed on the UE), L1 signaling may be used to report AI/ML model inference information to the network node. For example, in the first case, the L1 signaling may report the beam(s) based on the output of the AI/ML model inference and/or the L1-RSRP corresponding to the beam(s). In the second case, the L1 signaling may be used to report the beam(s) of N future time instance(s) based on the output of the AI/ML model inference, the L1-RSRP corresponding to the beam(s), and/or explicit or implicit information regarding one or more timestamps corresponding to the reported beam(s).

At least three alternatives may be defined for the monitoring a UE-side AI/ML model with potential down-selection. The alternatives may apply to the first case and the second case. The first alternative may involve UE-side model monitoring. For example, the UE may monitor the performance metric(s) of the AI/ML model and, based on the monitoring, determine whether to perform an operation (e.g., model selection, model activation, model deactivation, model switching, fallback, or the like). The second alternative may involve network-side model monitoring. For example, the network may monitor the performance metric(s) of the AI/ML model and, based on the monitoring, determine whether to perform an operation (e.g., model selection, model activation, model deactivation, model switching, fallback, or the like). The third alternative may involve hybrid model monitoring. For example, the UE may monitor the performance metric(s) of the AI/ML model, and the network may, based on the monitoring, determine whether to perform an operation (e.g., model selection, model activation, model deactivation, model switching, fallback, or the like).

In the first case and/or the second case, for a network-side AI/ML model, the network may perform model monitoring (e.g., “network-side model monitoring”). For example, the network may monitor the performance metric(s) of the AI/ML model and, based on the monitoring, determine whether to perform an operation (e.g., model selection, model activation, model deactivation, model switching, fallback, or the like). In this example, beam measurements may occur and a report for model monitoring may be generated.

In the first case and/or the second case, for a network-side AI/ML model, L1 beam reporting may be enhanced for AI/ML model inference. For example, the UE may report the measurement results of more than four beams in one reporting instance. Other L1 reporting enhancements may also be implemented.

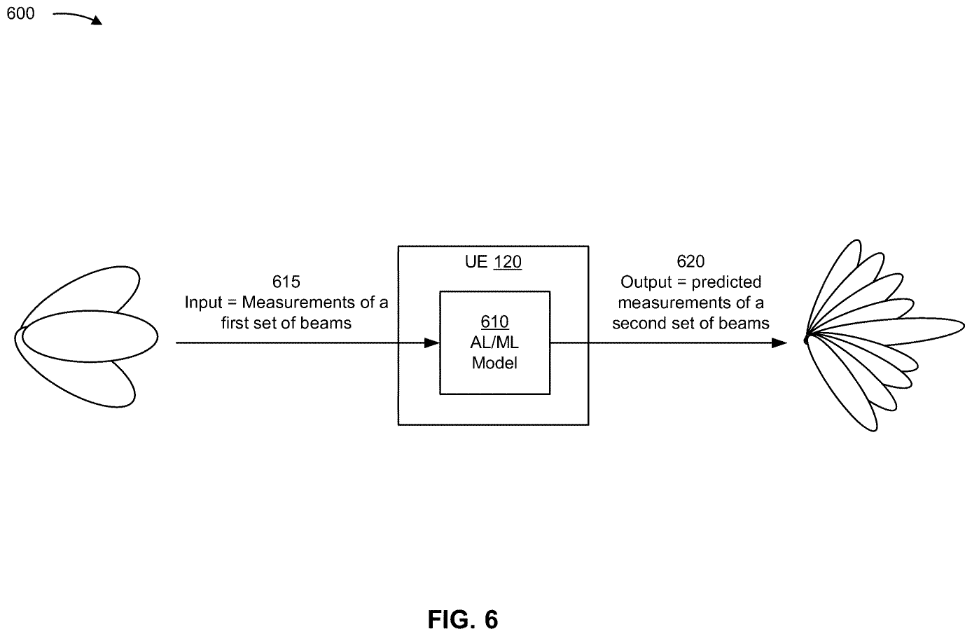

FIG. 6 is a diagram illustrating an example 600 of an AI/ML based beam management, in accordance with the present disclosure. As shown in FIG. 6, an AI/ML model 610 may be deployed at or on a UE 120. For example, a model inference host (such as a model inference host) may be deployed at, or on, a UE 120. The AI/ML model 610 may enable the UE 120 to determine one or more inferences or predictions based on data input to the AI/ML model 610.

For example, as shown by reference number 615, an input to the AI/ML model 610 may include measurements associated with a first set of beams. For example, a network node 110 may transmit one or more signals using respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 620, the AI/ML model 610 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 610. This may enable the AI/ML model 610 to output codebook based and/or non-codebook based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 610 may perform spatial-domain downlink beam predictions for beams included in the Set A beams based on measurement results of beams included in the Set B beams. As another example, the AI/ML model 610 may perform temporal downlink beam prediction for beams included in the Set A beams based on historic measurement results of beams included in the Set B beams.

As indicated above, FIG. 6 is provided as an example. Other examples may differ from what is described with regard to FIG. 6.

Some UE capabilities and behaviors may relate to a CSI processing unit (CPU), as described in 3GPP technical specification (TS) 38.214. A SimultaneousCSI-ReportsPerCC parameter (e.g., N_{CPU}) may indicate a per-component-carrier (CC) reported number of supported simultaneous CSI calculations (e.g., a quantity of CPUs per CC). A CC is a configured bandwidth that can be activated and deactivated for data and/or control communication of the UE via RRC signaling. A SimultaneousCSI-ReportsAllCC parameter (e.g., N_{CPU}) may indicate an all-CC reported number of supported simultaneous CSI calculations (e.g., a quantity of CPUs over all CCs).

For example, if Z CPUs are occupied for calculation of CSI reports in a given OFDM symbol, then the UE has N_{CPU}−L unoccupied CPUs. The UE may refrain from updating the N−M requested CSI reports with the lowest priorities. For example, N CSI reports may start occupying respective CPUs on the same OFDM symbol on which N_{CPU}−L CPUs are unoccupied. Each such CSI report n=0, . . . , N−1 may occupy

$${O}_{C P U}^{( n )} CPUs .$$

M, where 0≤M≤N, is the largest value such that

$${\sum }_{n = 0}^{M - 1} {O}_{C P U}^{( n )} \leq {N}_{C P U} - L holds .$$

The number of different CSI report settings comprising a single aperiodic CSI triggering state should not be greater than N_{CPU}.

An O_{CPU} parameter may indicate a specific quantity of occupied CPUs. O_{CPU} may be set to 0 if a reportQuantity parameter of the corresponding CSI report setting is set to none while the CSI resource set associated with the CSI report setting is configured with a trs-Info parameter. O_{CPU} may be set to 1 if the reportQuantity parameter of the corresponding CSI report setting is set to cri-RSRP, ssb-Index-RSRP, cri-SINR, or ssb-Index-SINR, or none while the CSI resource set associated with the CSI report setting is not configured with a trs-Info parameter. O_{CPU} may be set to Kₛ if the reportQuantity parameter of the corresponding CSI report setting is set to cri-RI-PMI-CQI, cri-RI-il, cri-RI-il-CQI, cri-RI-CQI, or cri-RI-L1-PMI-CQI, where Kₛ is the number of CSI-RS resources in the associated channel measurement resource (CMR) set.

For a CSI report having a reportQuantity parameter not set to none, CPU occupations may have a duration depending on whether the CSI report is periodic (or semi-periodic) or aperiodic. For periodic or semi-periodic CSI reports (excluding the initial semi-periodic CSI report carried on a physical uplink shared channel (PUSCH) after the DCI that is carried on a PDCCH and triggers the CSI report), the duration of a CPU occupation may begin at the first symbol of the earliest one of each CMR or interference measurement resource (IMR) on the latest occasion before the corresponding CSI reference resource, and may end at the last symbol of the configured PUSCH or physical uplink control channel (PUCCH) carrying the CSI report. For aperiodic CSI reports (or the initial semi-periodic CSI report carried on a PUSCH after the DCI that is carried on a physical downlink control channel (PDCCH) and triggers the CSI report), the duration of a CPU occupation may begin at the first symbol after the PDCCH triggering the CSI report and may end at the last symbol of the scheduled PUSCH carrying the CSI report.

For a CSI report having a reportQuantity parameter set to none and the trs-Info parameter not configured for the CMR set, CPU occupations may have a duration depending on whether the CSI report is semi-periodic or aperiodic. For semi-periodic CSI reports (excluding the initial semi-periodic CSI report carried on a physical uplink shared channel (PUSCH) after the downlink control information (DCI) that is carried on a PDCCH and triggers the CSI report), the duration of a CPU occupation may begin at the first symbol of the earliest one of each periodic or semi-periodic CSI-RS or SSB occasion for the CMR of an L1-RSRP computation, and may end

$${Z}_{3}^{′}$$

symbols after the last symbol of the latest one of the CSI-RS or SSB resource for the CMR for the L1-RSRP computation in each transmission occasion. For aperiodic CSI reports, the duration of a CPU occupation may begin at the first symbol after the PDCCH triggering the CSI report, and may end

$${Z}_{3}^{′}$$

symbols after the last symbol of the latest one of each CSI-RS or SSB resource for the CMR for the L1-RSRP computation.

$${Z}_{3}^{′}$$

and a corresponding value of Z₃ may be defined in telecommunications standards.

A UE 120 may have certain restrictions on a quantity of CMRs, a quantity of IMRs, and/or ports associated with the CMRs and/or IMRs. As one example, a UE may have a capability regarding a maximum number of configured or activated CSI-RS resources or ports. For example, per 3GPP TS 38.214, in any slot, the UE may not be expected to have more active CSI-RS ports or active CSI-RS resources in active bandwidth parts (BWPs) (where a BWP is a configured set of resource blocks that can be activated or deactivated for active communication via dynamic signaling) than a maximum number of CSI-RS ports or resources that the UE has reported via capability information. An aperiodic NZP-CSI-RS resource may be active starting from an end of a PDCCH containing a request for the CSI-RS and ending at the end of a scheduled PUSCH containing the report associated with this aperiodic CSI-RS. A semi-persistent CSI-RS may be active starting from an end of when the activation command is applied, and ending at an end of when the deactivation command is applied. A periodic CSI-RS may be active starting when the periodic CSI-RS is configured by higher layer signaling, and ending when the periodic CSI-RS configuration is released. If a CSI-RS resource is referred to N times by one or more CSI reporting settings, the CSI-RS resource and the CSI-RS ports within the CSI-RS resource are counted N times for the purpose of determining a number of active resources. A CSI reporting setting indicates a configuration for reporting CSI derived from a CSI-RS resource referred to by the CSI reporting setting.

A UE may signal a capability via capability information. The capability information may include various parameters indicating various capabilities. A parameter indicating a capability may be identified by a parameter name. Examples of parameter names and corresponding capabilities are provided below.

In some aspects, a capability may relate to a case where a UE is not configured to provide information regarding an L1 RSRP or an L1 SINR in a corresponding CSI report. In such aspects, per 3GPP TS 38.306, a csi-RS-IM-ReceptionForFeedback parameter may indicate whether a UE supports CSI-RS and CSI-RS for interference management (CSI-IM) reception for CSI feedback. For example, the UE may report the csi-RS-IM-ReceptionForFeedback parameter. The csi-RS-IM-ReceptionForFeedback parameter may include the following parameters: maxConfigNumberNZP-CSI-RS-PerCC, which indicates a maximum number of configured NZP-CSI-RS resources per CC; maxConfigNumberPortsAcrossNZP-CSI-RS-PerCC, which indicates the maximum number of ports across all configured NZP-CSI-RS resources per CC; maxConfigNumberCSI-IM-PerCC, which indicates the maximum number of configured CSI-IM resources per CC; maxNumberSimultaneousNZP-CSI-RS-PerCC, which indicates the maximum number of simultaneous CSI-RS-resources per CC; and totalNumberPortsSimultaneousNZP-CSI-RS-PerCC, which indicates the total number of CSI-RS ports in simultaneous CSI-RS resources per CC.

In some other aspects, a capability may relate to a case where a UE can be configured to provide information regarding an L1 RSRP or an L1 SINR in a corresponding CSI report. As one example, per 3GPP TS 38.306, a maxTotalResourcesForOneFreqRange parameter may indicate a maximum total number of SSB, CSI-RS, and CSI-IM resources configured to measure within a slot across all CCs in one frequency range for any of L1-RSRP measurement, L1-SINR measurement, pathloss measurement, beam failure detection (BFD), radio link monitoring (RLM), or new beam identification. A maxNumberResWithinSlotAcrossCC-OneFR parameter may indicate a maximum total number of SSB, CSI-RS, and CSI-IM resources configured to measure within a slot across all CCs in one frequency range for any of L1-RSRP measurement, L1-SINR measurement, pathloss measurement, BFD, RLM, or new beam identification. A maxNumberResAcrossCC-OneFR parameter may indicate a maximum total number of SSB, CSI-RS, and CSI-IM resources configured across all CCs in one frequency range for any of L1-RSRP measurement, L1-SINR measurement, pathloss measurement, BFD, RLM, or new beam identification. As another example, a maxTotalResourcesForAcrossFreqRanges parameter may indicate a maximum total number of SSB, CSI-RS, and CSI-IM resources configured to measure within a slot across all frequency ranges for any of L1-RSRP measurement, L1-SINR measurement, pathloss measurement, BFD, RLM, or new beam identification. A maxNumberResWithinSlotAcrossCC-AcrossFR parameter may indicate a maximum total number of SSB, CSI-RS, and CSI-IM resources that can be configured to measure within a slot across all frequency ranges for any of L1-RSRP measurement, L1-SINR measurement, pathloss measurement, BFD, RLM, or new beam identification. A maxNumberResAcrossCC-AcrossFR parameter may indicate a maximum total number of SSB, CSI-RS, and CSI-IM resources that can be configured across all frequency ranges for any of L1-RSRP measurement, L1-SINR measurement, pathloss measurement, BFD, RLM, or new beam identification.

In some instances, a CSI report may include predicted channel characteristics (e.g., predicted beam characteristics). However, a quantity and duration of occupied CPUs is not specifically defined for CSI reports that include predicted channel characteristics. Without a CPU quantity and/or duration specific to predicted channel characteristics, the UE may dedicate extraneous CPUs for generating CSI reports that include predicted channel characteristics. These extraneous CPUs may occupy UE resources that could, if unoccupied, be used for other operations.

Implementations described herein may resolve the quantity and/or duration of CPU occupation for CSI reports carrying predicted channel characteristics (e.g., channel characteristics prediction results). For example, some aspects may help determine whether, when prediction results are reported together with measurement results (e.g., for time domain beam prediction), the CSI report occupies one CPU or, given the additional AI/ML resources involved in generating the prediction results, multiple CPUs.

Some aspects may help determine whether the quantity of occupied CPUs based on AI/ML techniques per CSI report, and/or a maximum quantity of occupied CPUs based on AI/ML techniques per-CC or across all CCs, are separately reported as UE capabilities, since different UEs may implement AI/ML models, and budget total AI/ML computational resources, differently. For example, the quantity or quantities may further depend on the quantity and/or type of prediction targets involved.

Some aspects may help determine whether the duration of CPU occupation based on AI/ML techniques is different from the duration of CPU occupation associated with measurements for conventional CSI reports. For example, the UE may perform calculations related to beam measurements (e.g., pure measurement results) before carrying out the predictions, and the AI/ML models may not have been occupied during the time involved in such calculations. In some cases, the duration of CPU occupation based on AI/ML techniques differs from the duration of CPU occupation associated with measurements if the UE reports the beam measurement results in separate CSI reports over different slots (e.g., instead of reporting the beam measurements together with the prediction results).

FIG. 7 is a diagram illustrating an example 700 associated with identifying a quantity of CPUs, in accordance with the present disclosure. As shown in FIG. 7, example 700 includes communication between a network node 110 and a UE 120. In some aspects, network node 110 and UE 120 may be included in a wireless network, such as wireless network 100. Network node 110 and UE 120 may communicate via a wireless access link, which may include an uplink and a downlink.

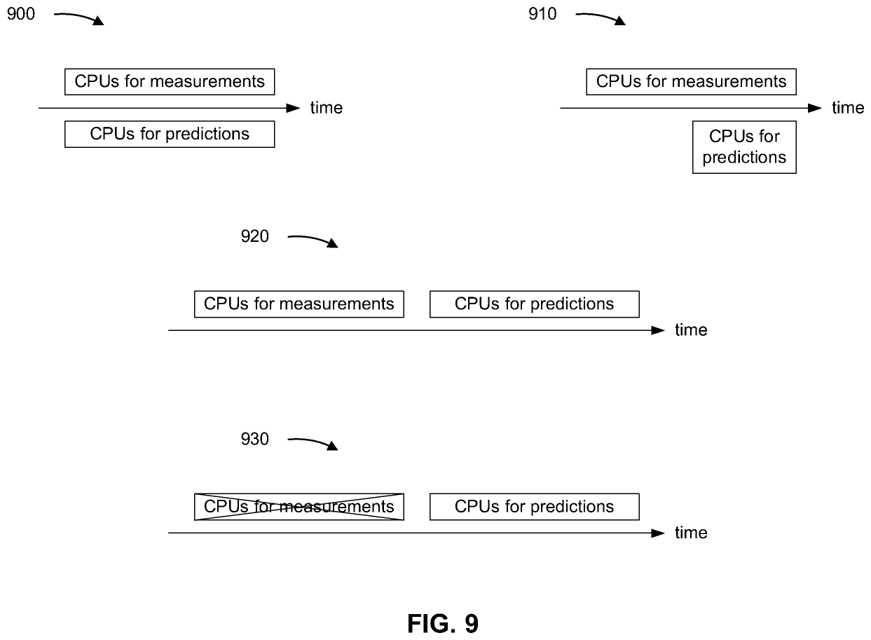

As shown by reference number 710, and as discussed in greater detail below, the UE 120 may transmit an indication of one or more candidate CPU handling schemes associated with a quantity of one or more CPUs associated with a CSI report that includes at least one predicted channel characteristic or with a duration of the one or more CPUs associated with the CSI report. For example, the candidate CPU handling scheme(s) may include a scheme in which the CPU(s) are associated with one or more measured channel characteristics, as discussed in greater detail below. Additionally, or alternatively, the candidate CPU handling scheme(s) may include a scheme in which the CPU(s) are not associated with one or more measured channel characteristics, as discussed in greater detail below. Additionally, or alternatively, the candidate CPU handling scheme(s) may include a scheme in which the CPU(s) have a given duration, as discussed below in relation to FIG. 9.

As shown by reference number 720, the UE 120 may transmit, and the network node 110 may obtain, capability information indicating a capability associated with one or more CPUs. For example, the capability information may indicate a total quantity of CPUs that can be occupied in a certain CC or across all CCs.

As shown by reference number 730, the network node 110 may output, and the UE 120 may receive, a message activating a CSI report. For example, the network node 110 may configure or trigger the UE 120 to generate and transmit a CSI report.

As shown by reference number 740, the UE 120 may identify a quantity of the one or more CPUs that are associated with the CSI report. The CSI report may include at least one predicted channel characteristic (e.g., beam prediction result). For example, the UE 120 may identify a quantity of CPUs being occupied for CSI reports having a reportQuantity parameter configured to include at least predicted channel characteristics.

In some examples, the UE 120 may identify the quantity based at least in part on a standard, predefined quantity of occupied CPUs and the corresponding duration of the occupation of the CPUs for such CSI reports (e.g., on a per-CSI-report basis). In some examples, the UE 120 may identify the quantity (and/or the duration) based at least in part on capabilities reported by the UE 120 regarding the quantity of occupied CPUs and the corresponding duration of the occupation of the CPUs for such CSI reports (e.g., on a per-CSI-report basis). For example, the capability information may include the quantity of occupied CPUs occupied for each CSI report, in addition to including the total quantity of CPUs that can be occupied in a certain CC or across all CCs.

The predicted channel characteristics may relate to certain CMRs/IMRs or virtual resources that are not actually transmitted by the network node 110. In some examples, the predicted channel characteristics may include one or more of an RSRP (e.g., an L1-RSRP), an SINR (e.g., an L1-SINR), one or more resources (e.g., one or more top K resources (e.g., Top-K-Resources), a rank indicator (RI), a CQI, a precoding matrix indicator (PMI), or the like. The top K resources may be defined in terms of L1 RSRP and/or L1 SINR strength among all prediction target resources.

The UE 120 may identify the predicted channel characteristics to be carried in the CSI report based at least in part on measuring CMRs and/or IMRs that are different from targeting resources that are transmitted by the network node 110 (e.g., set B beams). In some examples, the UE 120 may not identify the predicted channel characteristics based on actual measurements associated with the CMRs, IMRs, and/or virtual resources not actually transmitted by network node 110 (e.g., set A beams).

The UE 120 may carry the prediction for the predicted channel characteristics in at least one temporal, spatial, and/or frequency domain. For example, the set A beams and set B beams may be associated with a different temporal occasion, different spatial beams, and/or a different frequency spectrum.

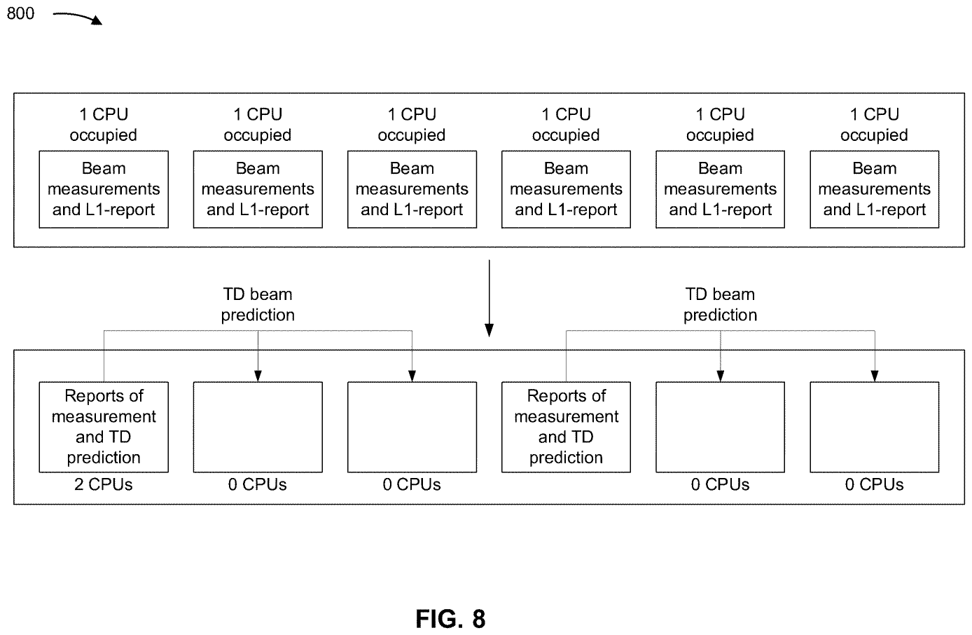

As explained in greater detail below with respect to FIG. 8, identifying the quantity of the one or more CPUs that are associated with the CSI report may enable reduction in overall CPU occupation, thereby decreasing computational burden on the UE 120. For example, identifying the quantity of the one or more CPUs may enable the UE 120 to generate and report predictions (e.g., predicted channel characteristics) using AI/ML techniques, which may allow the UE 120 to occupy fewer CPUs, as described with reference to FIG. 8 below.

As shown by reference number 750, and as discussed in greater detail below with respect to FIG. 9, the UE 120 may identify one or more durations of the CPU(s) associated with the CSI report (e.g., the UE 120 may identify one or more durations of the CPU occupation for channel characteristics prediction reports). For example, identifying the duration(s) may include identifying a start time of CPU occupation, an end time of CPU occupation, a length of time of CPU occupation, or the like. The UE 120 may transmit an indication of the duration(s) to the network node 110 (e.g., as part of the capability information). Identifying the duration(s) may help to ensure that the CPUs are not occupied for an extraneous amount of time.

As shown by reference number 760, the UE 120 may determine that the one or more CPUs associated with the CSI report are unoccupied. For example, the UE 120 may determine that the quantity of the one or more CPUs are unoccupied. For example, the UE 120 may determine that the quantity of the one or more CPUs to be used for generating predicted channel characteristics for the CSI report are available.

As shown by reference number 770, the UE 120 may transmit, and the network node 110 may obtain, a CSI report based at least in part on the determination that the one or more CPUs associated with the CSI report are unoccupied. The CSI report may indicate, to the network node 110, the predicted channel characteristics generated using the quantity of the one or more CPUs. The predicted channel characteristics in the CSI report may enable the network node 110 to perform beam management (e.g., to help ensure that the wireless access link between the network node 110 and the UE 120 continues to enable communication between the network node 110 and the UE 120).

As shown by reference number 780, the UE 120 may transmit updated capability information indicating a capability associated with one or more prediction resources (e.g., AI/ML resources). For example, the UE 120 may dynamically update any suitable capability information described herein (e.g., capability information associated with one or more CPUs). The capabilities of the UE 120 may change over time, for instance, in situations where AI/ML inference resources at the UE 120 vary dynamically. For example, to perform urgent (e.g., high-priority) AI/ML inference, the UE 120 may lower AI/ML capabilities for beam prediction).

The UE 120 may transmit (e.g., report) the updated capability information via MAC-CE or as part of the associated CSI report payload (e.g., the updated capability information may be carried in the associated CSI report payload). In some examples, the UE 120 may receive an indication from the network node 110 (e.g., a separate MAC-CE, such as a downlink MAC-CE containing an acknowledgment (ACK)) confirming that the network node 110 obtained the CSI report or uplink MAC-CE carrying the updated capability information. Upon receiving the indication, the UE 120 may apply the updated capabilities K ms after the network node 110 sent (e.g., transmitted or outputted) the downlink MAC-CE. K may be predefined in a telecommunications standard.

Transmitting updated capability information may enable the UE 120 to provide dynamic updates relating to AI/ML capabilities of the UE 120, which may help to ensure that the network node 110 obtains accurate and up-to-date AI/ML capabilities information of the UE 120.

As indicated above, FIG. 7 is provided as an example. Other examples may differ from what is described with respect to FIG. 7.

FIG. 8 is a diagram illustrating an example 800 associated with reducing (e.g., relaxing) a quantity of occupied CPUs, in accordance with the present disclosure. As shown, without identifying a quantity of CPUs associated with a CSI report that includes at least one predicted channel characteristic (e.g., which may enable time domain beam prediction), each L1-report occupies one CPU.

However, using time domain beam prediction (e.g., by identifying a quantity of CPUs associated with a CSI report that includes at least one predicted channel characteristic), on average, the quantity of occupied CPUs may be reduced by 33%. For example, as shown, the beam prediction may predict two future instances, and thus, only two CPUs are occupied for every three instances (e.g., one CPU for measurements and one CPU for time domain predictions). Low-complexity AI/ML models (e.g., beam change prediction) may be deployed at the UE 120, which may enable a relatively small quantity of CPUs to be occupied. In this example, the CPUs for time domain predictions may be dedicated for time domain beam prediction and may not necessarily be shared with other types of channel state feedback (CSF).

As indicated above, FIG. 8 is provided as an example. Other examples may differ from what is described with respect to FIG. 8.

In some examples, the CPU(s) associated with the CSI report that includes at least one predicted channel characteristic (e.g., channel characteristics prediction results) may also be associated with one or more measured channel characteristics. For example, the CPU(s) may be jointly occupied by CSI operations for CSI reports that carry predicted channel characteristics and CSI operations for CSI reports that carry measured channel characteristics. For example, CPU(s) occupied by CSI reports carrying predicted channel characteristics (e.g., reportQuantity parameters for AI/ML prediction) may be shared with other types of CSI reports carrying reportQuantity parameters for measurements.

Associating the CPU(s) with one or more measured channel characteristics may enable the UE 120 to avoid disclosing implementation details to the network node 110. For example, because the CPUs may be jointly occupied, the UE 120 may avoid indicating allocations of CPUs for the measured channel characteristics and allocations of CPUs for the predicted channel characteristics. As a result, the network node 110 may be prevented from collecting certain information regarding CPU-related processes carried out internally by the UE 120.

In certain scenarios, a CSI report may have a reportQuantity parameter that indicates quantities related to measured channel characteristics and to predicted channel characteristics. In some examples, the quantity of CPUs occupied by such CSI reports may be defined as the quantity of CPUs occupied for a CSI report having a reportQuantity parameter associated with quantities related to measured channel characteristics, plus P CPUs. P CPUs may be a quantity of at least one CPU that is associated with at least one predicted channel characteristic (e.g., occupied for determining the predicted channel characteristics). For instance, if the prediction is related to L1-RSRP/L1-SINR/top K resources, the UE 120 may allocate one additional CPU for the corresponding CSI report. Thus, reportQuantity parameters for measurements may be associated with a quantity of CPUs occupied for measured channel characteristics, and reportQuantity parameters for AI/ML prediction may be associated with P additional occupied CPUs that are shared with the CPUs for measured channel characteristics.

In certain scenarios, a CSI report may have a reportQuantity parameter that includes no measured channel characteristics (e.g., that includes only predicted channel characteristics). In some examples, the quantity of CPUs occupied by such CSI reports may be P (e.g., notwithstanding any calculations associated with measurement resources). In some examples, the quantity of CPUs occupied by such CSI reports may be P+P′. P′ CPUs may be a quantity of at least one CPU that is associated with one or more measurement resources. For example, P′ CPUs may be allocated for calculations associated with measurement resources. For instance, if the predicted channel characteristics relate to L1-RSRP/L1-SINR/top K resources, then P′ may be set to one, which may enable the UE 120 to calculate the L1-RSRP and/or L1-SINR value(s) of the measurement resources. Or, if the predicted channel characteristics relate to PMI, then P′ may be set to the quantity of CMRs used by the UE 120 to calculate the PMI of the CMRs. Thus, P′ CPUs may be occupied for calculation of measurements, and reportQuantity parameters for AI/ML prediction may be associated with P additional occupied CPUs that are shared with the CPUs for measured channel characteristics. P′ may equal any suitable number, including zero.

In some examples, the CPU(s) associated with the CSI report may not be associated with one or more measured channel characteristics. For example, the CPU(s) occupied by CSI reports that carry predicted channel characteristics may be separated from CSI reports that carry measured channel characteristics (e.g., separated from CSI reports that include reportQuantity parameters for measurements). For example, the UE 120 may report separate capabilities per-CC (e.g., SimultaneousCSI-ReportsPerCC-Prediction) and across all CCs (e.g., SimultaneousCSI-ReportsAllCC-Prediction) indicating a maximum quantity of simultaneously active CPUs for processing CSI reports carrying channel prediction results.

Not associating the CPU(s) associated with the CSI report with one or more measured channel characteristics may enable the UE 120 to distinguish between measurement tasks and prediction tasks by reporting separate sets of capabilities (e.g., one set for measurements and one set for predictions), which may enable the UE 120 to balance resources between measurement tasks and prediction tasks.

In certain scenarios, a CSI report may have a reportQuantity parameter that indicates quantities related to measured channel characteristics and to predicted channel characteristics. In some examples, the quantity of CPUs occupied by such CSI reports may be defined as the quantity of CPUs occupied for a CSI report having a reportQuantity parameter associated with quantities related to measured channel characteristics, plus P CPUs. In this example, P CPUs may be allocated for the total quantity of occupied CPUs associated with the SimultaneousCSI-ReportsPerCC-Prediction parameter, and the remaining quantity of CPUs occupied for quantities associated with measurement channel characteristics may be allocated for the total quantity of occupied CPUs associated with the SimultaneousCSI-ReportsPerCC and SimultaneousCSI-ReportsAllCC parameters. For instance, if the prediction is related to L1-RSRP/L1-SINR/top K resources, the UE 120 may allocate one additional CPU for the corresponding CSI report. Thus, reportQuantity parameters for measurements may be associated with a quantity of CPUs occupied for measurements (e.g., as per the SimultaneousCSI-ReportsPerCC and SimultaneousCSI-ReportsAllCC parameters), and reportQuantity parameters for AI/ML prediction may be associated with a quantity of occupied CPUs dedicated for AI/ML-based prediction (e.g., as per the SimultaneousCSI-ReportsPerCC and SimultaneousCSI-ReportsAllCC parameters).

In certain scenarios, a CSI report may have a reportQuantity parameter that includes no measured channel characteristics (e.g., that includes only predicted channel characteristics). In some examples, the quantity of CPUs occupied by such CSI reports may be P (e.g., notwithstanding any calculations associated with measurement resources). In some examples, the quantity of CPUs occupied by such CSI reports may be P+P′. P′ CPUs may be a quantity of at least one CPU that is associated with one or more measurement resources. For example, P′ CPUs may be allocated for calculations associated with measurement resources. For instance, if the predicted channel characteristics relate to L1-RSRP/L1-SINR/top K resources, then P′ may be set to one, which may enable the UE 120 to calculate the L1-RSRP and/or L1-SINR value(s) of the measurement resources. Or, if the predicted channel characteristics relate to PMI, then P′ may be set to the quantity of CMRs used by the UE 120 to calculate the PMI of the CMRs.

The P CPUs may be allocated for the total quantity of occupied CPUs that are associated with the SimultaneousCSI-ReportsPerCC-Prediction and SimultaneousCSI-ReportsAllCC-Prediction parameters. The P′ CPUs that are occupied for measurement types of quantities may be allocated for the total quantity of occupied CPUs associated with the SimultaneousCSI-ReportsPerCC and SimultaneousCSI-ReportsAllCC parameters. Thus, the P′ CPUs may be occupied for calculation of measurements (e.g., calculations of measurements may occupy measurement types of CPUs), as per the SimultaneousCSI-ReportsPerCC and SimultaneousCSI-ReportsAllCC parameters. The reportQuantity parameters for AI/ML prediction may be associated with P additional occupied CPUs that are separated from the measurement types of CPUs. For example, the AI/ML prediction may occupy CPUs dedicated for AI/ML based prediction, as per the SimultaneousCSI-ReportsPerCC-Prediction and SimultaneousCSI-ReportsAllCC-Prediction parameters. As noted above, P′ may equal any suitable number, including zero.

In some examples, regardless of whether or not the one or more CPUs associated with the CSI report are also associated with measured channel characteristics, and regardless of whether or not the CSI report includes a reportQuantity parameter that indicates the measured channel characteristics, the value of P may be predefined (e.g., predefined based on a telecommunications standard). In some examples, the predefined value of P may be based on the prediction conditions. If the prediction is in the time domain for T future time occasions, then P may increase proportionally with T (e.g., P=p_{T}T, where p_{T} is predefined according to a telecommunications standard). If the prediction relates to R prediction target resources, then P may increase proportionally with R (e.g., P=p_{R}R, where p_{R} is predefined according to a telecommunications standard). If the prediction relates to C prediction target resources, then P may increase proportionally with C (e.g., P=p_{C}C, where p_{C} is predefined according to a telecommunications standard). If the prediction is made across different serving cells (e.g., if the measurement resources are from a first serving cell and the prediction targets relate to a second serving cell), then P may increase proportionally with the cell-center distance between the serving cells and/or with the carrier-frequency difference between the serving cells.

In some examples, regardless of whether or not the one or more CPUs associated with the CSI report are also associated with measured channel characteristics, the capability information may indicate one or more of a quantity of at least one CPU that is associated with the at least one predicted channel characteristic (e.g., P CPUs) or a quantity of at least one CPU that is associated with one or more measurement resources (e.g., P′ CPUs). For example, the UE 120 may report the value of P and/or the value of P′ as a capability of the UE 120. In some examples, the UE 120 may report different values of P and/or P′ for different conditional values (e.g., values of T, R, cell-center distance between two serving cells, carrier-frequency difference between two serving cells, or any combination thereof). Indicating the value(s) of P and/or P′ in the capability information may enable the network node 110 to use the value(s) of P and/or P′ to activate the CSI report and/or may enable the UE 120 to identify the quantity of the CPU(s) that are associated with the CSI report based on the value(s) of P and/or P′.

FIG. 9 is a diagram illustrating aspects 900, 910, 920, and 930 associated with identifying one or more durations of the CPU(s) associated with the CSI report, in accordance with the present disclosure. At least aspects 900, 910, and 920 may apply to a first scenario, and at least aspects 900, 910, 920, and 930 may apply to a second scenario. In the first scenario, a CSI report may include a reportQuantity parameter that indicates quantities related to measured channel characteristics and to predicted channel characteristics. In the second scenario, a CSI report may have a reportQuantity parameter that includes no measured channel characteristics (e.g., that includes only predicted channel characteristics).

In aspect 900, a duration of the CPU(s) (“CPUs for predictions”) may begin at a start time, and end at an end time, of a duration of a CPU associated with one or more measured channel characteristics (“CPUs for measurements”). For example, the CPU associated with one or more measured channel characteristics may include CPUs occupied for measurement calculations. Aspect 900 may reduce complexity by allowing the durations of CPUs associated with CSI reports that include predicted channel characteristics and the durations of CPUs associated with measurement channel characteristics to have the same start and end times.

In aspect 910, a duration of the CPU(s) (“CPUs for predictions”) may begin at, or an offset after, a start time of a duration of a CPU associated with one or more measured channel characteristics (“CPUs for measurements”) and end at a last symbol at which the CSI report is transmitted. The CPU(s) associated with one or more measured channel characteristics may include CPUs occupied for calculations related to measurement resources and/or measurement-based quantities, and the CPU(s) associated with the CSI report may include CPUs occupied for calculating channel characteristics predictions. The start time of the duration of the CPU associated with the measured channel characteristic(s) may be predefined in a telecommunications standard. In some examples, the CPU(s) associated with the CSI report may be occupied for a time window (e.g., for only a time window) that starts from the time domain starting point of the CPU occupations for calculations related to measurement resources plus a time domain offset and that ends at the last symbol of the PUCCH or PUSCH carrying the CSI report. A duration of the CPU(s) that begins at, or an offset after, a start time of the duration of a CPU associated with one or more measured channel characteristics and ends at a last symbol at which the CSI report is transmitted may reduce an amount of time for which a CPU associated with the CSI report is occupied, thereby enabling efficient use of resources at the UE 120.

In aspect 920, a duration of a CPU associated with one or more measured channel characteristics (“CPUs for measurements”) ends a first offset after a start time of the duration of the CPU associated with the one or more measured channel characteristics. A duration of the CPU(s) associated with the CSI report may begin at, or a second offset after, an end time of the duration of the CPU associated with the measured channel characteristic(s) and end at a last symbol at which the CSI report is transmitted.

The CPU(s) associated with one or more measured channel characteristics may include CPUs occupied for calculations related to measurement resources and/or measurement-based quantities, and the CPU(s) associated with the CSI report may include CPUs occupied for calculating channel characteristics predictions. The start time of the duration of the CPU associated with the measured channel characteristic(s) may be predefined in a telecommunications standard.

In some examples, the CPU associated with one or more measured channel characteristics may end at an occasion that is based on (e.g., equal to) a starting occasion of the CPU (e.g., an occasion when the start time of the CPU occurs) plus a first time domain offset (e.g., the first offset). In some examples, the CPU(s) associated with the CSI report may be occupied for a time window (e.g., for only a time window) that starts from the time domain ending point of the CPU occupations for calculations related to measurement resources plus a second time domain offset (e.g., the second offset) and that ends at the last symbol of the PUCCH or PUSCH carrying the CSI report.

A duration of the CPU(s) associated with the CSI report that begins at, or a second offset after, an end time of the duration of the CPU associated with the measured channel characteristic(s) and that ends at a last symbol at which the CSI report is transmitted may enable a CPU associated with the CSI report to be occupied after the CPU associated with the measured channel characteristic(s), which may help to manage resource usage at the UE 120.

In aspect 930, a duration of an unoccupied CPU (“CPUs for measurements”) may end a first offset after a start time of the duration of the unoccupied CPU. A duration of the CPU(s) associated with the CSI report may begin at, or a second offset after, an end time of the duration of the unoccupied CPU and end at a last symbol at which the CSI report is transmitted. The unoccupied CPU may be unoccupied by, for example, measurement calculations. The CPU(s) associated with the CSI report may be occupied for calculating channel characteristics predictions.

The CPU(s) associated with the CSI report may be occupied for a time window (e.g., for only a time window) that starts from the time domain ending point of the unoccupied CPU (e.g., as described above with reference to the time domain ending point of the CPU occupations for calculations related to measurement resources in aspect 920) plus a time domain offset (e.g., the second offset) and that ends at the last symbol of the PUCCH or PUSCH carrying the CSI report.

A duration of the CPU(s) associated with the CSI report that begins at, or a second offset after, an end time of the duration of the unoccupied CPU and end at a last symbol at which the CSI report is transmitted may enable a CPU associated with the CSI report to be occupied after an unoccupied CPU, which may help to manage resource usage at the UE 120.

Any suitable offset described above with reference to aspects 910, 920, and/or 930 may be predefined (e.g., in a telecommunications standard) and/or reported by the UE 120 in the capability information transmitted to the network node 110. The offsets may be predefined and/or reported for different conditional values (e.g., values of T, R, cell-center distance between two serving cells, carrier-frequency difference between two serving cells, or any combination thereof). The offsets may have any suitable values. For example, the second offset in aspect 920 and/or the second offset in aspect 930 may have a predefined value of zero.

As indicated above, FIG. 9 is provided as an example. Other examples may differ from what is described with respect to FIG. 9.

As noted above with respect to reference number 710, the UE 120 may transmit an indication of one or more candidate CPU handling schemes associated with a quantity of one or more CPUs associated with a CSI report that includes at least one predicted channel characteristic or with a duration of the one or more CPUs associated with the CSI report. The indication of the one or more candidate CPU handling schemes may include a preference (e.g., a priority, ranking, or the like) of the UE 120 among a plurality of the candidate CPU handling schemes. For example, the UE 120 may report a preference for certain options relating to CPU occupation quantities and/or options relating to CPU occupation duration as described above. In some examples, the UE 120 may also dynamically update the preference via RRC, MAC-CE, or the like.

Transmitting the indication of one or more candidate CPU handling schemes may inform the network node 110 regarding preferences of the UE 120 for given candidate CPU handling schemes. Thus, for example, the network node 110 may select a candidate CPU handling scheme and configure the UE 120 for the selected CPU handling scheme based on the preference of the UE 120. As a result, the UE 120 may be configured with a preferred CPU handling scheme.

FIG. 10 is a diagram illustrating an example process 1000 performed, for example, by a UE, in accordance with the present disclosure. Example process 1000 is an example where the UE (e.g., UE 120) performs operations associated with identification of a quantity of one or more CPUs.

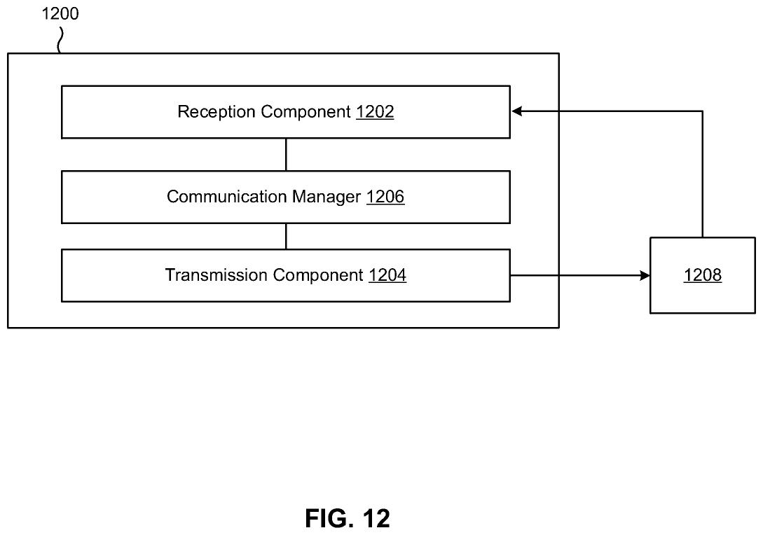

As shown in FIG. 10, in some aspects, process 1000 may include transmitting capability information indicating a capability associated with one or more CPUs (block 1010). For example, the UE (e.g., using transmission component 1204 and/or communication manager 1206, depicted in FIG. 12) may transmit capability information indicating a capability associated with one or more CPUs, as described above.

As further shown in FIG. 10, in some aspects, process 1000 may include receiving a message activating a CSI report (block 1020). For example, the UE (e.g., using reception component 1202 and/or communication manager 1206, depicted in FIG. 12) may receive a message activating a CSI report, as described above.

As further shown in FIG. 10, in some aspects, process 1000 may include identifying a quantity of the one or more CPUs that are associated with the CSI report, wherein the CSI report includes at least one predicted channel characteristic (block 1030). For example, the UE (e.g., using communication manager 1206, depicted in FIG. 12) may identify a quantity of the one or more CPUs that are associated with the CSI report, wherein the CSI report includes at least one predicted channel characteristic, as described above. In some examples, the UE may identify the quantity based at least in part on a standard, predefined quantity of occupied CPUs and the corresponding duration of the occupation of the CPUs for such CSI reports (e.g., on a per-CSI-report basis). In some examples, the UE may identify the quantity based at least in part on capabilities reported by the UE regarding the quantity of occupied CPUs (e.g., on a per-CSI-report basis).

Process 1000 may include additional aspects, such as any single aspect or any combination of aspects described below and/or in connection with one or more other processes described elsewhere herein.

In a first aspect, process 1000 includes determining that the one or more CPUs associated with the CSI report are unoccupied, and transmitting the CSI report based at least in part on determining that the one or more CPUs associated with the CSI report are unoccupied. For example, the UE may determine that the one or more CPUs are unoccupied based on the availability of the one or more CPUs for generating the CSI report.

In a second aspect, alone or in combination with the first aspect, the at least one predicted channel characteristic includes one or more of an RSRP, an SINR, one or more resources, an RI, a CQI, or a PMI.

In a third aspect, alone or in combination with one or more of the first and second aspects, the one or more CPUs associated with the CSI report are associated with one or more measured channel characteristics.

In a fourth aspect, alone or in combination with one or more of the first through third aspects, the one or more CPUs associated with the CSI report are not associated with one or more measured channel characteristics.

In a fifth aspect, alone or in combination with one or more of the first through fourth aspects, the capability information indicates one or more of a quantity of at least one CPU, of the one or more CPUs, that is associated with the at least one predicted channel characteristic or a quantity of at least one CPU, of the one or more CPUs, that is associated with one or more measurement resources.

In a sixth aspect, alone or in combination with one or more of the first through fifth aspects, process 1000 includes identifying one or more durations of the one or more CPUs associated with the CSI report. For example, the UE may identify the one or more durations based at least in part on the seventh, eighth, ninth, and/or tenth aspects described as follows.

In a seventh aspect, alone or in combination with one or more of the first through sixth aspects, at least one duration of the one or more durations begins at a start time, and ends at an end time, of a duration of a CPU associated with one or more measured channel characteristics.

In an eighth aspect, alone or in combination with one or more of the first through seventh aspects, at least one duration of the one or more durations begins at, or an offset after, a start time of a duration of a CPU associated with one or more measured channel characteristics and ends at a last symbol at which the CSI report is transmitted.

In a ninth aspect, alone or in combination with one or more of the first through eighth aspects, a duration of a CPU associated with one or more measured channel characteristics ends a first offset after, a start time of the duration of the CPU associated with the one or more measured channel characteristics, and at least one duration of the one or more durations begins at, or a second offset after, an end time of the duration of the CPU associated with the one or more measured channel characteristics and ends at a last symbol at which the CSI report is transmitted.

In a tenth aspect, alone or in combination with one or more of the first through ninth aspects, a duration of an unoccupied CPU ends a first offset after a start time of the duration of the unoccupied CPU, and at least one duration of the one or more durations begins at, or a second offset after, an end time of the duration of the unoccupied CPU and ends at a last symbol at which the CSI report is transmitted.

In an eleventh aspect, alone or in combination with one or more of the first through tenth aspects, process 1000 includes transmitting updated capability information indicating a capability associated with one or more prediction resources. For example, the UE may dynamically update any suitable capability information described herein (e.g., capability information associated with one or more CPUs).

In a twelfth aspect, alone or in combination with one or more of the first through eleventh aspects, process 1000 includes transmitting an indication of one or more candidate CPU handling schemes associated with the quantity of the one or more CPUs associated with the CSI report or with a duration of the one or more CPUs associated with the CSI report. For example, the candidate CPU handling scheme(s) may include a scheme in which the CPU(s) are associated with one or more measured channel characteristics, as discussed in greater detail below. Additionally, or alternatively, the candidate CPU handling scheme(s) may include a scheme in which the CPU(s) are not associated with one or more measured channel characteristics, as discussed in greater detail below. Additionally, or alternatively, the candidate CPU handling scheme(s) may include a scheme in which the CPU(s) have a given duration, as discussed above in relation to FIG. 9.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with identification of a quantity of one or more CPUs.

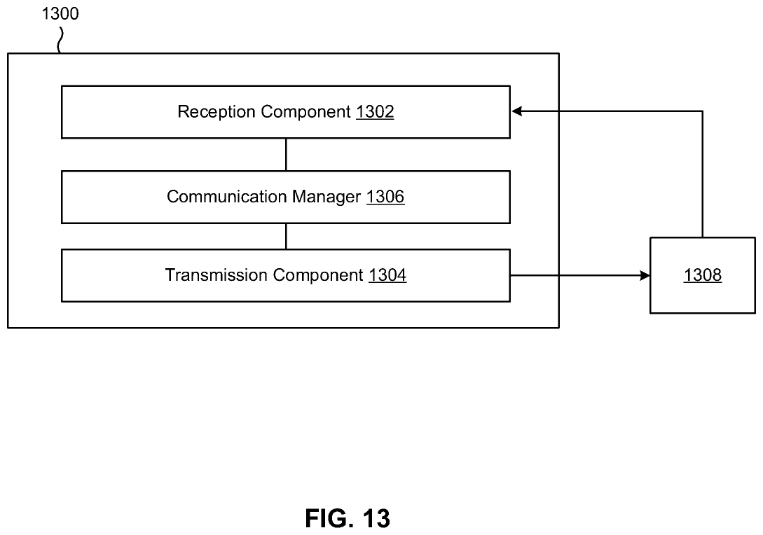

As shown in FIG. 11, in some aspects, process 1100 may include obtaining capability information indicating a capability associated with one or more CPUs (block 1110). For example, the network node (e.g., using reception component 1302 and/or communication manager 1306, depicted in FIG. 13) may obtain capability information indicating a capability associated with one or more CPUs, as described above.

As further shown in FIG. 11, in some aspects, process 1100 may include outputting a message activating a CSI report, wherein the message prompts a UE to identify a quantity of the one or more CPUs that are associated with the CSI report, and wherein the CSI report includes at least one predicted channel characteristic (block 1120). For example, the network node (e.g., using transmission component 1304 and/or communication manager 1306, depicted in FIG. 13) may output a message activating a CSI report, wherein the message prompts a UE to identify a quantity of the one or more CPUs that are associated with the CSI report, and wherein the CSI report includes at least one predicted channel characteristic, as described above. In some examples, the UE may identify the quantity based at least in part on a standard, predefined quantity of occupied CPUs and the corresponding duration of the occupation of the CPUs for such CSI reports (e.g., on a per-CSI-report basis). In some examples, the UE may identify the quantity based at least in part on capabilities reported by the UE regarding the quantity of occupied CPUs (e.g., on a per-CSI-report basis).

Process 1100 may include additional aspects, such as any single aspect or any combination of aspects described below and/or in connection with one or more other processes described elsewhere herein.

In a first aspect, process 1100 includes obtaining the CSI report based at least in part on a determination that the one or more CPUs associated with the CSI report are unoccupied. For example, the UE may determine that the one or more CPUs are unoccupied based on the availability of the one or more CPUs for generating the CSI report.

In a second aspect, alone or in combination with the first aspect, the at least one predicted channel characteristic includes one or more of an RSRP, an SINR, one or more resources, an RI, a CQI, or a PMI.

In a third aspect, alone or in combination with one or more of the first and second aspects, the one or more CPUs associated with the CSI report are associated with one or more measured channel characteristics.

In a fourth aspect, alone or in combination with one or more of the first through third aspects, the one or more CPUs associated with the CSI report are not associated with one or more measured channel characteristics.

In a fifth aspect, alone or in combination with one or more of the first through fourth aspects, the capability information indicates one or more of a quantity of at least one CPU, of the one or more CPUs, that is associated with the at least one predicted channel characteristic or a quantity of at least one CPU, of the one or more CPUs, that is associated with one or more measurement resources.

In a sixth aspect, alone or in combination with one or more of the first through fifth aspects, the UE further identifies a duration of the one or more CPUs associated with the CSI report.

In a seventh aspect, alone or in combination with one or more of the first through sixth aspects, process 1100 includes obtaining updated capability information indicating a capability associated with one or more prediction resources. For example, the UE may dynamically update any suitable capability information described herein (e.g., capability information associated with one or more CPUs).

In an eighth aspect, alone or in combination with one or more of the first through seventh aspects, process 1100 includes obtaining an indication of one or more candidate CPU handling schemes associated with the quantity of the one or more CPUs associated with the CSI report or with a duration of the one or more CPUs associated with the CSI report. For example, the candidate CPU handling scheme(s) may include a scheme in which the CPU(s) are associated with one or more measured channel characteristics, as discussed in greater detail below. Additionally, or alternatively, the candidate CPU handling scheme(s) may include a scheme in which the CPU(s) are not associated with one or more measured channel characteristics, as discussed in greater detail below. Additionally, or alternatively, the candidate CPU handling scheme(s) may include a scheme in which the CPU(s) have a given duration, as discussed above in relation to FIG. 9.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit capability information indicating a capability associated with one or more CPUs. The reception component 1202 may receive a message activating a CSI report. The communication manager 1206 may identify a quantity of the one or more CPUs that are associated with the CSI report, wherein the CSI report includes at least one predicted channel characteristic.

The communication manager 1206 may determine that the one or more CPUs associated with the CSI report are unoccupied.

The transmission component 1204 may transmit the CSI report based at least in part on determining that the one or more CPUs associated with the CSI report are unoccupied.

The communication manager 1206 may identify one or more durations of the one or more CPUs associated with the CSI report.

The transmission component 1204 may transmit updated capability information indicating a capability associated with one or more prediction resources.

The transmission component 1204 may transmit an indication of one or more candidate CPU handling schemes associated with the quantity of the one or more CPUs associated with the CSI report or with a duration of the one or more CPUs associated with the CSI report.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may obtain capability information indicating a capability associated with one or more CPUs. The transmission component 1304 may output a message activating a CSI report, wherein the message prompts a UE to identify a quantity of the one or more CPUs that are associated with the CSI report, and wherein the CSI report includes at least one predicted channel characteristic.

The reception component 1302 may obtain the CSI report based at least in part on a determination that the one or more CPUs associated with the CSI report are unoccupied.

The reception component 1302 may obtain updated capability information indicating a capability associated with one or more prediction resources.

The reception component 1302 may obtain an indication of one or more candidate CPU handling schemes associated with the quantity of the one or more CPUs associated with the CSI report or with a duration of the one or more CPUs associated with the CSI report.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: transmitting capability information indicating a capability associated with one or more CPUs; receiving a message activating a CSI report; and identifying a quantity of the one or more CPUs that are associated with the CSI report, wherein the CSI report includes at least one predicted channel characteristic.

Aspect 2: The method of Aspect 1, further comprising: determining that the one or more CPUs associated with the CSI report are unoccupied; and transmitting the CSI report based at least in part on determining that the one or more CPUs associated with the CSI report are unoccupied.

Aspect 3: The method of any of Aspects 1-2, wherein the at least one predicted channel characteristic includes one or more of: an RSRP, an SINR, one or more resources, an RI, a CQI, or a PMI.

Aspect 4: The method of any of Aspects 1-3, wherein the one or more CPUs associated with the CSI report are associated with one or more measured channel characteristics.

Aspect 5: The method of any of Aspects 1-3, wherein the one or more CPUs associated with the CSI report are not associated with one or more measured channel characteristics.

Aspect 6: The method of any of Aspects 1-5, wherein the capability information indicates one or more of a quantity of at least one CPU, of the one or more CPUs, that is associated with the at least one predicted channel characteristic or a quantity of at least one CPU, of the one or more CPUs, that is associated with one or more measurement resources.

Aspect 7: The method of any of Aspects 1-6, further comprising: identifying one or more durations of the one or more CPUs associated with the CSI report.

Aspect 8: The method of Aspect 7, wherein at least one duration of the one or more durations begins at a start time, and ends at an end time, of a duration of a CPU associated with one or more measured channel characteristics.

Aspect 9: The method of Aspect 7, wherein at least one duration of the one or more durations begins at, or an offset after, a start time of a duration of a CPU associated with one or more measured channel characteristics and ends at a last symbol at which the CSI report is transmitted.

Aspect 10: The method of Aspect 7, wherein a duration of a CPU associated with one or more measured channel characteristics ends a first offset after, a start time of the duration of the CPU associated with the one or more measured channel characteristics, and wherein at least one duration of the one or more durations begins at, or a second offset after, an end time of the duration of the CPU associated with the one or more measured channel characteristics and ends at a last symbol at which the CSI report is transmitted.

Aspect 11: The method of Aspect 7, wherein a duration of an unoccupied CPU ends a first offset after a start time of the duration of the unoccupied CPU, and wherein at least one duration of the one or more durations begins at, or a second offset after, an end time of the duration of the unoccupied CPU and ends at a last symbol at which the CSI report is transmitted.

Aspect 12: The method of any of Aspects 1-11, further comprising: transmitting updated capability information indicating a capability associated with one or more prediction resources.

Aspect 13: The method of any of Aspects 1-12, further comprising: transmitting an indication of one or more candidate CPU handling schemes associated with the quantity of the one or more CPUs associated with the CSI report or with a duration of the one or more CPUs associated with the CSI report.

Aspect 14: A method of wireless communication performed by a network node, comprising: obtaining capability information indicating a capability associated with one or more CPUs; and outputting a message activating a CSI report, wherein the message prompts a UE to identify a quantity of the one or more CPUs that are associated with the CSI report, and wherein the CSI report includes at least one predicted channel characteristic.

Aspect 15: The method of Aspect 14, further comprising: obtaining the CSI report based at least in part on a determination that the one or more CPUs associated with the CSI report are unoccupied.

Aspect 16: The method of any of Aspects 14-15, wherein the at least one predicted channel characteristic includes one or more: of an RSRP, an SINR, one or more resources, an RI, a CQI, or a PMI.

Aspect 17: The method of any of Aspects 14-16, wherein the one or more CPUs associated with the CSI report are associated with one or more measured channel characteristics.

Aspect 18: The method of any of Aspects 14-17, wherein the one or more CPUs associated with the CSI report are not associated with one or more measured channel characteristics.

Aspect 19: The method of any of Aspects 14-18, wherein the capability information indicates one or more of a quantity of at least one CPU, of the one or more CPUs, that is associated with the at least one predicted channel characteristic or a quantity of at least one CPU, of the one or more CPUs, that is associated with one or more measurement resources.

Aspect 20: The method of any of Aspects 14-19, wherein the UE further identifies a duration of the one or more CPUs associated with the CSI report.

Aspect 21: The method of any of Aspects 14-20, further comprising: obtaining updated capability information indicating a capability associated with one or more prediction resources.

Aspect 22: The method of any of Aspects 14-21, further comprising: obtaining an indication of one or more candidate CPU handling schemes associated with the quantity of the one or more CPUs associated with the CSI report or with a duration of the one or more CPUs associated with the CSI report.

Aspect 23: An apparatus for wireless communication at a device, comprising a processor; memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
transmit capability information indicating a capability associated with one or more channel state information (CSI) processing units (CPUs);
receive a message activating a CSI report; and
identify a quantity of the one or more CPUs that are associated with the CSI report, wherein the CSI report includes at least one predicted channel characteristic.

2. The UE of claim 1, wherein the one or more processors are further configured to:
determine that the one or more CPUs associated with the CSI report are unoccupied; and
transmit the CSI report based at least in part on determining that the one or more CPUs associated with the CSI report are unoccupied.

3. The UE of claim 1, wherein the at least one predicted channel characteristic includes one or more of: a reference signal received power (RSRP), a signal-to-interference-plus-noise ratio (SINR), one or more resources, a rank indicator (RI), a channel quality indicator (CQI), or a precoding matrix indicator (PMI).

4. The UE of claim 1, wherein the one or more CPUs associated with the CSI report are associated with one or more measured channel characteristics.

5. The UE of claim 1, wherein the one or more CPUs associated with the CSI report are not associated with one or more measured channel characteristics.

6. The UE of claim 1, wherein the capability information indicates one or more of a quantity of at least one CPU, of the one or more CPUs, that is associated with the at least one predicted channel characteristic or a quantity of at least one CPU, of the one or more CPUs, that is associated with one or more measurement resources.

7. The UE of claim 1, wherein the one or more processors are further configured to:
identify one or more durations of the one or more CPUs associated with the CSI report.

8. The UE of claim 7, wherein at least one duration of the one or more durations begins at a start time, and ends at an end time, of a duration of a CPU associated with one or more measured channel characteristics.

9. The UE of claim 7, wherein at least one duration of the one or more durations begins at, or an offset after, a start time of a duration of a CPU associated with one or more measured channel characteristics and ends at a last symbol at which the CSI report is transmitted.

10. The UE of claim 7, wherein a duration of a CPU associated with one or more measured channel characteristics ends a first offset after, a start time of the duration of the CPU associated with the one or more measured channel characteristics, and wherein at least one duration of the one or more durations begins at, or a second offset after, an end time of the duration of the CPU associated with the one or more measured channel characteristics and ends at a last symbol at which the CSI report is transmitted.

11. The UE of claim 7, wherein a duration of an unoccupied CPU ends a first offset after a start time of the duration of the unoccupied CPU, and wherein at least one duration of the one or more durations begins at, or a second offset after, an end time of the duration of the unoccupied CPU and ends at a last symbol at which the CSI report is transmitted.

12. The UE of claim 1, wherein the one or more processors are further configured to:
transmit updated capability information indicating a capability associated with one or more prediction resources.

13. The UE of claim 1, wherein the one or more processors are further configured to:
transmit an indication of one or more candidate CPU handling schemes associated with the quantity of the one or more CPUs associated with the CSI report or with a duration of the one or more CPUs associated with the CSI report.

14. A network node for wireless communication, comprising:
a memory; and
one or more processors, coupled to the memory, configured to:
obtain capability information indicating a capability associated with one or more channel state information (CSI) processing units (CPUs); and
output a message activating a CSI report, wherein the message prompts a user equipment (UE) to identify a quantity of the one or more CPUs that are associated with the CSI report, and wherein the CSI report includes at least one predicted channel characteristic.

15. The network node of claim 14, wherein the one or more processors are further configured to:
obtain the CSI report based at least in part on a determination that the one or more CPUs associated with the CSI report are unoccupied.

16. The network node of claim 14, wherein the at least one predicted channel characteristic includes one or more of: a reference signal received power (RSRP), a signal-to-interference-plus-noise ratio (SINR), one or more resources, a rank indicator (RI), a channel quality indicator (CQI), or a precoding matrix indicator (PMI).

17. The network node of claim 14, wherein the one or more CPUs associated with the CSI report are associated with one or more measured channel characteristics.

18. The network node of claim 14, wherein the one or more CPUs associated with the CSI report are not associated with one or more measured channel characteristics.

19. The network node of claim 14, wherein the capability information indicates one or more of a quantity of at least one CPU, of the one or more CPUs, that is associated with the at least one predicted channel characteristic or a quantity of at least one CPU, of the one or more CPUs, that is associated with one or more measurement resources.

20-22. (canceled)

23. A method of wireless communication performed by a user equipment (UE)x, comprising:
transmitting capability information indicating a capability associated with one or more channel state information (CSI) processing units (CPUs);
receiving a message activating a CSI report; and
identifying a quantity of the one or more CPUs that are associated with the CSI report, wherein the CSI report includes at least one predicted channel characteristic.

24-30. (canceled)
